(19) United States
(12) Patent Application Publication
(10) Pub. No.: US 2012/0073970 A1
(43) Pub. Date: Mar. 29, 2012

(54) Amperometric Oxygen Sensor

(75) Inventors: Sea-Fue Wang, Taipei (TW); Anthony Lee, Taipei (TW); Wen-Shuo Hsieh, Taipei (TW)

(73) Assignee: NATIONAL TAIPEI UNIVERSITY OF TECHNOLOGY, Taipei (TW)

(21) Appl. No.: 13/160,674

(22) Filed: Jun. 15, 2011

(30) Foreign Application Priority Data
Sep. 29, 2010 (TW) 099133188

(51) Int. Cl. G01N 27/333

(52) U.S. Cl. 204/416

(57) ABSTRACT

An amperometric oxygen sensor for sensing the partial pressure of oxygen is disclosed. The amperometric oxygen sensor having a multilayered body which comprises a plurality of oxygen ion conductor layers interposed between a plurality of oxygen-porous electrode layers. Oxygen from a sample gas enters porous cathode layer of the sensor, through the ion conductor diffuses to anode because of a potential difference, and then an amperometric current is measured, which is proportional to the partial pressure of the oxygen. The amperometric oxygen sensor further comprises a heating member embedded within the sensor body and a heating controller electrically connects with the heating member to heat and maintain the sensor at working temperature, about 500˜800° C. An electrical insulator layer, but not thermal insulator, is blocked between the heating member and the oxygen-porous electrode strips so as to prevent the amperometric current from electromagnetic field interference.

### FIELD OF THE INVENTION

The present invention relates to a oxygen sensor, particularly to an amperometric oxygen sensor.

### BACKGROUND OF THE INVENTION

The oxygen sensors have long been used in combustion control field such as engines in motor vehicles or boiler for ensuring complete combustion and raising combustion efficiency so as to reduce exhausting gases emission.

The most widely used and known oxygen sensors in present market are mainly based on an oxygen ion conductor as a solid-state electrolyte. For example, a potentiometric oxygen sensor is based on a partially stabilized zirconia, hereinafter called PSZ. In an example, two fluxes of gases containing different partial pressure of oxygen are separated from each other by the PSZ plate. As a result, the oxygen ions will tend to move from one gas containing a high concentration of oxygen to the other one of lower concentration. While entering the PSZ plate, oxygen molecules dissociate on an entry surface of PSZ plate and then obtain electrons to form oxygen ions. These ions then diffuse through the PSZ plate, loss electrons again, and back to its original state, exiting from the other side of the PSZ plate. The foregoing mechanism generates an emf between the two sides of the ion conductors. Thus, if a reference gas and an unknown gas are conducted in and the emf is measured thereafter, the oxygen partial pressure of an unknown gas can be calculated according to the Nernst equation.

$$EMF = {t}_{i} ( \frac{RT}{n F} ) ln ( \frac{{P}_{{O}_{2}}}{{P}_{{O}_{2}}^{′}} )$$

Where tᵢ is the ionic transference number, R is the gas constant, T is the absolute temperature, n is the number of electrons involved in the electrode reaction (in this case, n=4), F is the Faraday constant, and P_{O2} and P′_{O2} are the oxygen partial pressures of the first and second gases, respectively.

However, there are some problems demanded to be overcome. The first one is the working temperature of the sensor needs to reach a range of about 800° C. to reduce an internal contact resistance while detecting a current. The second one is that the cost of the sensor is expensive because of the rather high cost of stabilized zirconia, and the high melting point, about 2700° C. Therefore, there are some rooms for improvement.

Recently, another kind of oxygen sensor, an amperometric sensors have been developed, which the oxygen partial pressure can be measured without a reference gas. The amperometric sensors use yittria-stabilized zirconia as the solid-state electrolyte, platinum or other noble metals as its cathode and anode. After a voltage is applied on the electrodes, oxygen ions diffuse from the cathode to the anode through the ion conductor. At the same time, a current is measured, whose value is proportional to the concentration of the oxygen. Therefore, the more accurate the amperometric current is measured, the more precise the oxygen concentration can be calculated. The amperometric sensors have the benefits include high stability, simple structure that profits to minimize the size. However, the disadvantages are: a very high working temperature, too long recovery time and it is constrained to a use for lower oxygen concentration determination.

In U.S. Pat. No. 6,592,731B1, Lawless discloses an amperometric sensor comprising a sensor body defined by a plurality of oxygen-porous electrode layer and at least one oxygen ion conductor layer. The oxygen ion conductor layer is interposed between a plurality of oxygen-porous electrode layer to reduce the difficulty of the fabrication. In the sensor, a heating member is embedded in the sensor body to provide a heating function which are controlled by a heat controller to hold the sensor at a working temperature between about 500˜800.

Nevertheless, since the oxygen concentration is determined by the detected current, the amperometric sensor is vulnerable to an electromagnetic field and thus loss its accuracy during a heating process by using a heating member applied a current. The effects include the sensitivity of the sensors drops and the detected amperometric current is disturbed. Besides, owing to the difference in thermal expansion coefficients between ion conductor and the oxygen-porous electrode layer, an internal thermal stress remained and cumulated in the sensor body as the amperometric sensor is heated. The thermal stress may lead the oxygen ion conductor to have crevices, and further to affect the lifetime of the amperometric sensor.

### BRIEF SUMMARY OF THE INVENTION

Accordingly, the present invention provides an amperometric oxygen sensor for determining the oxygen partial pressure of a gas. The amperometric oxygen sensor comprises a sensor body formed of an oxygen ion conductor, an oxygen-porous anode, an oxygen-porous cathode, a heating member and an electrical insulator layer.

The oxygen-porous anode has a comb shape, including a first anode part and a second anode part, wherein the first anode part is mounted on a first sidewall of the sensor body and the second anode part are a plurality of porous anode metal strips separated from each other, arranged in parallel along the first anode part and embedded in the sensor body

The oxygen-porous cathode is disposed opposite to the oxygen-porous anode, and also has a comb shape, including a first cathode part and a second cathode part. The first cathode part is mounted on a second sidewall of the sensor, which is opposite to the first sidewall. The second cathode part are a plurality of porous cathode metal strips, which are separated from each other, and arranged in parallel along the first cathode part. The porous cathode metal strips are embedded in the sensor body, interlaced and overlapped with the porous anode metal strips in a predetermined length.

The heating member embedded within the sensor body so as to heat and hold the amperometric oxygen sensor at a working temperature. The electrical insulator layer, but not a thermal insulator, is disposed between the heating member and the porous electrode metal strips so as to prevent the amperometric current from electromagnetic field interference during heating process.

Preferably, the material of the heating member is selected from the group consisting of platinum, gold, palladium and rhodium. The oxygen ion conductor is selected from the group consisting of the yttria-stabilized zirconia (Y₂O₃—ZrO₂), the bismuth oxide doped with alkaline-earth metal elements or transition elements, and cerium oxide doped with rare earth elements or transition elements.

In addition, to serve as a buffer layer and isolate the electromagnetic field caused by the heating member applied a current, the thickness of the electrical insulator layer varies in the range of about 0.01˜0.03 mm as selected material. The preferable material is aluminum oxide (Al₂O₃) doped with rare earth or transition elements.

Accordingly, the present invention not only is easy to construct, but also has higher oxygen sensitivity, accuracy, and longer lifetime. The electrical insulator layer is used to relax the thermal stress, and to prevent the disturbance of the electromagnetic field, solving the problem in the prior art which exists for a long period.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic representation of an oxygen sensor in accordance with the present invention.

FIG. 2A and FIG. 2B are illustrations of different embodiments of the pattern of the heating member.

FIG. 3A and FIG. 3B are illustrations of the different embodiments of processes for fabrication of the electrical insulator layer and the heating member.

FIG. 4 is a schematic representation of an oxygen sensor in accordance with another embodiment of the present invention; and

FIG. 5 is a schematic representation of an oxygen sensor in accordance with another embodiment of the present invention.

### DETAILED DESCRIPTION THE INVENTION

The above purpose, further features, advantages, and benefits of the invention will become apparent in the following descriptions taken in conjunction with the following drawings. It is to be understood that the foregoing general description and following detailed descriptions of the preferred embodiments of this invention are exemplary and explanatory.

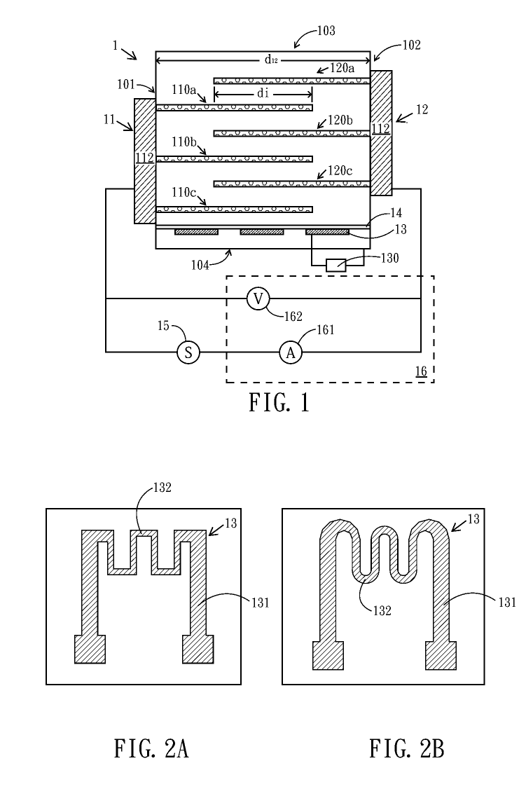

Please refer to FIG. 1, which illustrates an amperometric oxygen sensor 1 for determining the oxygen partial pressure in accordance with a preferred embodiment of the present invention. The sensor body 10 has a multilayer of oxygen ion conductor served as the solid-state electrolyte. In a preferred embodiment, the oxygen ion conductor is selected from the group consisting of yttria-stabilized zirconia (Y₂O₃—ZrO₂), bismuth oxide and cerium oxide, wherein the bismuth oxide is doped with alkaline-earth metal elements such as Ba, Sr, Tl and La, or transition elements such as Y, Nb and the cerium oxide is doped with rare earth elements or transition elements.

The amperometric oxygen sensor 1 comprises a porous anode 11, a porous cathode 12, a heating member 13, and an electrical insulator layer 14.

The porous anode 11 is like a hair comb having a row of porous toothed strips 110a, 110b, 110c along one side of a comb holder 112. The structure of the porous cathode 12 is the same, but its porous toothed strips 120a, 120b, 120c, are disposed in a direction opposite to the porous anode strips 110a, 110b, 110c and separated by a predetermined distance.

The two comb holders 112, 122 are mounted on the opposite sidewalls 101, 102 of the sensor body 10. The porous toothed strips 110a, 110b, 110c, hereafter called porous anode strips 110a˜110c, and the porous toothed strips 120a, 120b, 120c, hereafter called porous cathode strips 120a˜120c, are embedded in the sensor body and interlaced with each other. All of them are separated by the oxygen ion conductor.

The overlapping length between the porous anode strips 110a˜110c and the porous cathode strips 120a˜120c is designated as dᵢ; and the distance between the first sidewall 101 and the second sidewall 102 is designated as d₁₂. The ratio of dᵢ to d₁₂ is preferably about 0.5˜0.9. In addition, in a preferred embodiment of the present invention, the sensor body 10 has a size of about 4 mm (L)×2 mm (W)×4 mm (H).

The materials of porous anode 11 and the porous cathode 12 are selected from the platinum or silver. The electrode having 5˜50% of its volume occupied by pores is one preferred embodiment.

The external measuring devices 16 includes an amperometric current meter 161 and a voltmeter 162 connected with a voltage source 15, which provides a potential difference so as to drive the oxygen ion (O²⁻) to diffuse from one electrode to another through the oxygen ion conductor. Accordingly, the oxygen concentration contained in the unknown gas can be obtained according to the amperometric current meter 161 and the voltmeter 162.

The heating member 13 embedded within the oxygen ion conductor of the sensor body 10 is controlled by a heating controller 130 so as to apply a energy to heat and make the amperometric oxygen sensor 1 to hold at a predetermined working temperature range.

Preferably, the conductive trace of heating member 13 are depicted, as shown in FIGS. 2A and 2B, including a portion with low resistivity 131 and the other with high resistivity 132 which may in a shape of “sine wave” in FIG. 2B, or “square wave” in FIG. 2A. The width of the portion with high resistivity 132 is about 0.1˜0.5 mm.

The material of the heating member 13 is selected from a group consisting of platinum, gold, palladium and rhodium.

In one preferred embodiment of the present invention, the oxygen ion conductor of the sensor body 10 is selected from yttria-stabilized zirconia (Y₂O₃—ZrO₂) and a working temperature range is between about 500˜800. To alleviate the EMI, an insulator layer 14 in electrical but not in thermal, is stacked on or under the heating members 13 where they are located at the bottom and/or the top of the sensor body 10 so that the porous anode 11 and cathode 12 will not “see” the heat electrode 13. The electrical insulator layer 14 has a thermal conductivity at least larger than 1 w/m·k.

In addition, the electrical insulator layer 14 can also be served as a buffer to relax the thermal stress caused by the thermal expansion coefficient difference between the oxygen ion conductor of the sensor body 10, and the porous electrodes. The difference of their thermal expansion coefficients is in the range of about 3·10⁻⁶·K⁻¹.

The electrical insulator layer 14 is selected from a group consisting of alumina, magnesium aluminate, silicon carbide, spinel, AlN, ZrO₂, HfO₂, SiO₂, and a combination thereof depending on the thermal expansion coefficient of the material of the oxygen ion conductor to be selected.

In one embodiment of the present invention, the oxygen ion conductor is Y₂O₃—ZrO₂, whose thermal expansion coefficient depending on the concentration of doped yttrium in zirconium oxide and in a range of about 10×10⁻⁶˜11×10⁻⁶ K⁻¹. To compensate that, an aluminum oxide (Al₂O₃) layer doped with rare earth or transition elements is chosen as the electrical insulator layer 14 with a thickness between about 0.01˜0.03 mm.

The amperometric oxygen sensor 1 of the present invention is laminated by a plurality of the ceramic tapes, each of which is fabricated by a tape casting method. As is known in the ceramic art, the tape casting is a process for making a multilayered sensor body 10, wherein the heating member 13, the porous anode strips 110a˜110c, the porous cathode strips 120a˜120c and the electrical insulator layer 14 interspersed between the ceramic tapes are fabricated by the same.

The tape casting method comprises the steps of ball milling and mixing a ceramic powder with a solvent, and a dispersion, adding a binder and a plasticizing agent and then continuously ball milling until a slurry is mixed well. Next, the slurry is uniformly rubbed on a substrate to form a slurry film by a blade against a plate. After drying, the slurry film becomes a raw biscuit film having a roughly uniform thickness. The raw biscuit film is then further degreased and sintered to form a ceramic tape.

Thereafter, the ceramic tapes are screen printed the patterns to form a heating member 13, a porous cathode 12, and a porous anode 11, respectively, and piled in a predetermined order so as to form a stack as shown in FIG. 1. The stack is sintered at a temperature between about 1150˜1300 and held for about 3 hours at an atmospheric or a higher pressure so as to form the oxygen sensor body.

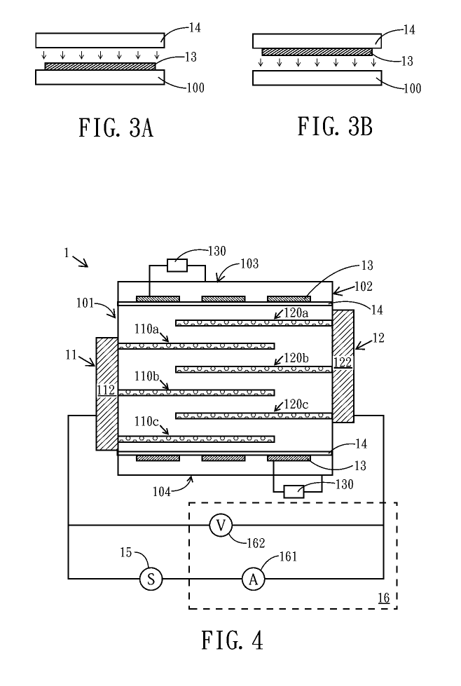

Taking the structure of the sensor shown in the FIG. 1 as an example, there are two methods for fabricating the heating member 13 and the electrical insulator layer 14. Please refer to FIG. 3A, a laminated sequence from the bottom is a ceramic tape 100, a heating member 13, and an insulator layer 14. FIG. 3B shows another embodiment of the laminated sequence, a pattern is printed on a lower surface of the ceramic tape of the electrical insulator layer 14 firstly, and then followed by stacking onto the ceramic tape 100 of the sensor body 10.

According to another embodiment of the present invention is shown in FIG. 4. The amperometric oxygen sensor 1 comprises not only one set of the heating member 13 and the electrical insulator layer 14, but two so that the sensor body 10 can be more rapidly heated to reach the working temperature and expectedly to have a better uniform temperature distribution. One is embedded near the top surface 103 of the sensor body 10, and the other is embedded near the bottom surface 104. In the similar way, these two electrical insulator layers 14 are used to block the heating member 13 from the anode 11 and cathode 12, respectively.

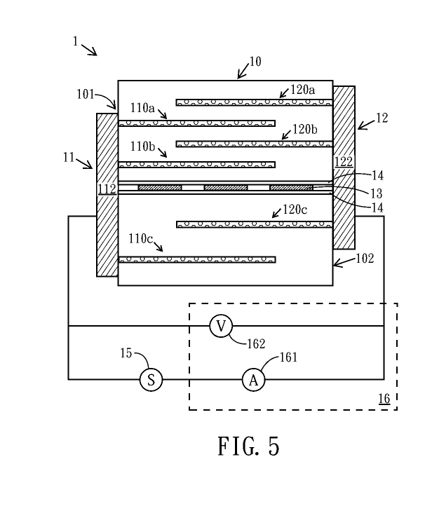

A schematic representation of the amperometric oxygen sensor of another embodiment is shown in FIG. 5. As seen in FIG. 5, the heating member 13 is arranged between the porous anode strips 110b and porous cathode strips 120c. Two electrical insulator layers 14 are inserted between the heating member 13 and these porous strips 110b, 120c, respectively. The advantage of the structure is the electrical insulator layers 14 can more effectively relax the thermal stress.

As aforementioned, the electrical insulator layer is disposed between the heating member and the sensor electrode so that the oxygen sensor can be prevented the current from the electromagnetic interference while the sensor is heated at a high working temperature. Thus, the sensitivity and the accuracy of the amperometric oxygen sensor can thus be significantly improved.

Furthermore, the electrical insulator layer can be regarded as a buffer. The thermal stress residual at the internal sensor body during the heating and annealing process can be relaxed. Thus, the risk of the crevice in the sensor body can be diminished, extending the lifetime of the amperometric oxygen sensor.

While the preferred embodiment of the invention has been illustrated and described, it will be appreciated that various changes and modifications can be made therein without departing from the spirit and scope of the invention.

What is the claimed is:

1. An amperometric oxygen sensor for determining the oxygen partial pressure of a gas, said amperometric oxygen sensor comprising:
a sensor body formed of an oxygen ion conductor;
an oxygen-porous anode including a first anode part and a second anode part, wherein said first anode part is mounted on a first sidewall of said sensor body and said second anode part are a plurality of porous anode metal strips separated from each other, arranged in parallel along said first anode part and embedded in said sensor body;
an oxygen-porous cathode including a first cathode part and a second cathode part wherein said first cathode part mounted on a second sidewall of said sensor, wherein said second sidewall is opposite to said first sidewall, and said second cathode part are a plurality of porous cathode metal strips separated from each other, arranged in parallel along said first cathode part, embedded in said sensor body, interlaced and overlapped with said porous anode metal strips in a predetermined length;
a heating member embedded in said sensor body to heat said sensor body to a working temperature; and
an electrical insulator layer embedded in said sensor body and disposed between said heating member and said porous electrode metal strips so as to prevent the amperometric current from electromagnetic field interference when said heating member heats said sensor body.

2. The amperometic oxygen sensor as claimed in claim 1, wherein the thermal conductivity of said electrical insulator layer is at least higher than about 1 w/m·k, and the difference of the thermal expansion coefficient between said electrical insulator layer and said oxygen ion conductor is in the range of 3×10⁻⁶ K⁻¹.

3. The amperometic oxygen sensor as claimed in claim 1, wherein said heating member is disposed between one of said porous anode metal strips and one of said porous cathode metal strips.

4. The amperometic oxygen sensor as claimed in claim 3, said amperometic oxygen sensor comprising two electrical insulator layers, one of said electrical insulator layer is disposed between said heating member and said porous anode metal strips, and the other is disposed between said heating member and said porous cathode metal strips.

5. The amperometic oxygen sensor as claimed in claim 1, wherein the material of said heating member is selected from the group consisting of platinum, gold, palladium and rhodium.

6. The amperometic oxygen sensor as claimed in claim 1, wherein the oxygen ion conductor is selected from the group consisting of the yttria-stabilized zirconia (Y₂O₃—ZrO₂), the bismuth oxide doped with alkaline-earth metal elements or transition elements, and cerium oxide doped with rare earth elements or transition elements.

7. The amperometic oxygen sensor as claimed in claim 1, wherein the material of said electrical insulator layer is selected from the group consisting of alumina, magnesium aluminate, silicon carbide, spinel, AlN, ZrO₂, HfO₂ and SiO₂.

8. The amperometic oxygen sensor as claimed in claim 1, wherein the oxygen ion conductor is yttria-stabilized zirconia, and said electrical insulator layer is aluminum oxide (Al₂O₃) layer doped with rare earth or transition elements with the thickness between 0.01˜0.03 mm.
